(19) United States
(12) Patent Application Publication
(10) Pub. No.: US 2010/0206127 A1
(43) Pub. Date: Aug. 19, 2010

(54) METHODS AND APPARATUS FOR IMPROVING THE MANOEUVRABILITY OF A VEHICLE

(75) Inventor: Jonathan Charles Wheals, Warwickshire (GB)

Correspondence Address: GIFFORD, KRASS, SPRINKLE,ANDERSON & CITKOWSKI, P.C, PO BOX 7021, TROY, MI, 48007-7021, US

(73) Assignee: RICARDO UK LTD, West Sussex (GB)

(21) Appl. No.: 12/443,253

(22) PCT Filed: Sep. 28, 2007
(86) PCT No.: PCT/GB07/03700

§ 371 Date: Jan. 5, 2010

(30) Foreign Application Priority Data
Sep. 28, 2006 (GB) 0619113.4
Sep. 3, 2007 (GB) 0717076.4

(51) Int. Cl. B62D 11/06

(52) U.S. Cl. 74/665 T

(57) ABSTRACT

An axle differential (200) for a vehicle includes a differential gear cluster (206) arranged in communication with a torque biasing gear cluster (208), wherein the torque biasing gear cluster is configured for varying the proportion of drive torque between the two outputs (204). A first drive path provides input (201) to the differential gear cluster and a second drive path provides input (202) to the torque biasing gear cluster, either independently of the first drive path or by diverting torque from the first drive path. A pivot turn axle differential is also provided, wherein even and odd epicyclic gear trains can be selected to cause rotation of the axle outputs in the same or opposite directions.

The present invention relates to methods and apparatus for improving vehicle manoeuvrability, more particularly, but not exclusively, for improving the turning ability of multi-axle vehicles.

It is well known that off-road or rough terrain wheeled vehicles may be fitted with three or more axles to ensure improved traction and stability when negotiating adverse surface conditions. The improved traction and also the reduction in ground pressure achievable through such multi-axle vehicles enables the transport of heavy loads across difficult terrain.

U.S. Pat. No. 4,407,381 and U.S. Pat. No. 3,799,362 are examples of wheeled vehicles having three or more axles for transporting heavy or dangerous loads. An object of the invention is to improve the manoeuvrability of such vehicles.

According to one aspect of the invention, there is provided a torque biasing axle differential for a vehicle, the axle differential including two outputs and a mechanical arrangement configured for varying the proportion of drive torque between the two outputs, wherein the axle differential includes first and second drive paths for transmitting torque to said mechanical arrangement.

The second drive path may be independent of said first drive path. In one embodiment, the axle differential includes first and second drive pinions arranged for receiving input from separate drive shafts of a vehicle. The second drive shaft may be selectively arranged for communication with said mechanical arrangement and may be arranged for selectively diverting torque to said mechanical arrangement from the first drive path.

The mechanical arrangement preferably includes a differential gear cluster arranged in communication with a torque biasing gear cluster, wherein the torque biasing gear cluster is configured for varying the proportion of drive torque between the two outputs.

The first drive path is preferably configured for communication with said differential gear cluster and the second drive path is preferably configured for communication with said torque biasing gear cluster. The torque biasing gear cluster preferably includes a control element and the second drive path is preferably arranged for transmitting drive to said control element.

The mechanical arrangement may include a plurality of torque biasing gear clusters, in which case additional drive paths may be incorporated, e.g. a drive path for each torque biasing gear cluster.

The first drive path is preferably arranged to provide input directly to the differential gear cluster, e.g. via a first drive pinion coupled to or arranged for communication with a first drive shaft or torque source of the vehicle.

In preferred embodiments, the second drive path communicates with the torque biasing gear cluster independently of said first drive path, e.g. via a separate chive pinion coupled to or arranged for communication with an alternative drive shaft or torque source of the vehicle.

In another embodiments, the second drive path and/or one or more additional drive paths may be arranged for selectively diverting torque from said first drive path, e.g. via separate drive pinions selectively engagable with a common drive shaft or torque source of the vehicle.

In a preferred embodiment, the first drive path includes a drive shaft arranged for receiving input from the primary torque source of the vehicle. The primary torque source may take the form of a vehicle engine, e.g. with torque transmitted from the engine via a transmission, or the primary torque source may take the form of a motor (e.g. electric or hydraulic or a hybrid motor). The second and/or each additional drive path may include additional drive shafts arranged for selective communication with the primary torque source of the vehicle, e.g. via a selectively operable coupling such as a clutch or CVT. In other embodiments, an additional torque source may be provided for the second drive path and/or for each additional drive path, independent of the primary torque source. However, in other embodiments the second and/or each additional drive path may include one or more drive shafts arranged for receiving input from the first drive path, e.g. via a clutch or CVT.

In a preferred embodiment, the differential gear cluster is in the form of an epicyclic differential gear cluster, which may be of known form, e.g. as described and illustrated in WO2006/010931 (incorporated herein by reference). The epicyclic differential gear cluster preferably includes an annulus, planet gears, a planet carrier and a sun gear, wherein the annulus is arranged for driving the sun gear via said planet gears, with the sun gear arranged for coupling to one of said two outputs of the axle differential, and wherein the planet carrier is coupled to the other of said two outputs.

In other embodiments, the differential gear cluster may be of a bevel-type arrangement or a ‘parallel axis’-type arrangement. It will be understood that a bevel type differential gear cluster may include two torque biasing gear clusters, one on either side of the axle.

The or each torque biasing gear cluster may comprise one or more epicyclic gear trains, preferably arranged about one of said outputs of the axle differential. In such embodiments, the epicyclic gear trains preferably comprise an annulus, planet gears, a planet carrier and a sun gear. In a preferred embodiment, a torque biasing gear cluster includes two epicyclic gear trains, wherein a planet carrier is common to said two gear trains, in conjunction with joined sun gears, or joined planet gears, or joined ring gears. Examples of such arrangements are described and illustrated in WO2006/010931 (incorporated herein by reference).

In a preferred embodiment, the axle differential includes a first torque biasing gear cluster having a plurality of epicyclic gear trains and incorporating a planet carrier which is common to at least two epicyclic gear trains, wherein the second drive path of the axle differential is arranged for driving said common planet carrier.

The axle differential may include first and second torque biasing gear clusters, each having a plurality of epicyclic gear trains and each incorporating a planet carrier which is common to at least two epicyclic gear trains, wherein the second drive path of the axle differential is arranged for driving the common planet carrier of the first torque biasing gear cluster and an additional drive path is arranged for driving the common planet carrier of the second torque biasing gear cluster.

The above embodiments have particular application in reducing the turning circle of a wheeled vehicle, either during steering of a moving vehicle or in providing a pivot turn capability, i.e. wherein the centroid of the vehicle remains is nominally stationary. The above embodiments also provide for improved yaw stability. It should be understood that the embodiments are not limited to wheeled vehicles, and may have application in other vehicle technologies, e.g. in the manoeuvrability of tracked vehicles and marine vehicles.

According to another aspect of the invention, there is provided a wheeled vehicle having multiple axles, wherein at least one axle incorporates an axle differential in accordance with one or more of the above embodiments.

According to further aspect of the invention, there is provided a marine vehicle incorporating an axle differential in accordance with one or more of the above aspects of the invention, e.g. for controlling the output torque for screw or propeller type propulsion devices.

According to a still further aspect of the invention, there is provided a method of controlling a vehicle having an axle differential in accordance with one or more of the above embodiments.

According to another aspect of the invention, there is provided a method of controlling a wheeled multi axle vehicle wherein each axle incorporates an axle differential according to any of the above embodiments, and wherein:
a) the wheels on one side of the vehicle are locked against rotation and the axle differentials are used to rotate the wheels on the other side of the vehicle; or
b) the axle differentials are used to cause rotation of the wheels on one side the vehicle in a first sense and rotation of the wheels on the opposite side of the vehicle in an opposite sense; or
c) the vehicle includes a front axle, a rear axle and at least one inner axle arranged between the front and rear axles, and wherein the axle differentials are configured and/or controlled so that the speed of rotation of the wheels at the front and or rear axle is higher than the speed of rotation of the wheels at the inner axle(s); or
d) the vehicle includes a front axle, a rear axle and at least one inner axle arranged between the front and rear axles, and wherein the axle differentials at the front and rear axles are operated to cause rotation of the wheel on one side of the axle in an opposite sense to the direction of rotation of the wheel on the opposite side of the axle, and wherein the axle differential is modulated so as to control the yaw rate of the vehicle.

According to yet a further aspect of the invention, there is provided a multi wheeled vehicle consisting of two or more axles for driving wheels on opposing sides of the vehicle, each axle comprising at least one independent selectively operable speed change device, whereby at least one wheel on a first of said sides of the vehicle can be rotated independently and in opposite rotational sense to the wheels on the opposing side of the vehicle.

Preferably, in a method of controlling a vehicle in accordance with the above aspect of the invention, at least one wheel is operated at a speed in excess of the free rolling speed so as to minimise the coefficient of friction between the tyre and road surface in the lateral direction.

According to another aspect of the invention there is provided a method of controlling a wheeled multi axle vehicle having a front axle, a rear axle and at least one inner axle arranged between the front and rear axles, the method comprising the step of rotating the front and or rear axles at a higher speed than the wheels at the inner axle(s), so as to reduce the lateral resistance of the wheels.

The direction of rotation of the wheels at the front axle is preferably different to the direction of rotation of the wheels at the rear axle.

Preferably, the or each inner axle is arranged adjacent the centroid of the vehicle and the front and rear axles are remote from the centroid of the vehicle, so that the lateral resistance is reduced away from the centroid, thereby reducing the yaw torque required to rotate the vehicle.

The speed of rotation of the axles is preferably controlled via axle differentials of the kind referred to above. In other embodiments, each axle or each wheel is controlled using independent electric motors. It may be preferred to control the inner axle(s) using a torque biasing axle differential and to control the front and or rear axles or wheels using independent electric motors. However, in other multiple axle vehicles any combination of motor driven axle(s) and torque biasing controlled axle(s) may be applied.

According to a further aspect of the invention there is provided a method of controlling a wheeled multi axle vehicle having a front axle, a rear axle and an inner axle arranged between the front and rear axles, the method comprising the steps of controlling the wheels at the front and rear axles to rotate in a first direction on one side of the vehicle and in an opposite direction on the opposite side of the vehicle, and modulating an axle differential at the inner axle so as to control the yaw rate of the vehicle.

According to a still further aspect of the invention, there is provided a method of controlling an axle differential in a vehicle, the axle differential having a primary input for receiving torque from a torque source of the vehicle (e.g. the engine or a motor), two outputs for driving wheels on either side of the vehicle, a differential gear unit for receiving torque from said primary input, and a torque biasing gear unit for varying the proportion of torque between the two outputs, the method comprising the steps of selectively applying ‘torque to the torque biasing unit independently of the differential gear module via a second input.

The method may include the use of a first driveline to supply torque to said first input, and a second driveline which is controlled to selectively divert torque from said first drive line to said second input, e.g. via a clutch or CVT. It may be preferred to brake input to the epicyclic differential gear module when diverting torque to said second input.

In other embodiments, the method may include the use of a first driveline to supply torque to said first input, and a second driveline to supply torque to said second input independently of said first driveline, e.g. via a separate torque source such as a motor.

According to yet a further aspect of the invention, there is provided a pivot turn differential for a vehicle axle, the differential including an input and two outputs, and two drive paths for communicating drive between the input and said outputs, each drive path having a selectively operable coupling arranged in communication with an epicyclic gear train, and wherein the epicyclic gear train for one of said drive paths has an even number of planet gears and the epicyclic gear train for the other of said drive paths has an odd number of planet gears.

The differential may include a sliding member which is movable for selective coupling of drive torque between the input and said drive paths. A separate sliding member may be provided per drive path, and each drive path may include a synchroniser for communication with the sliding member.

Other aspects and preferred features of the invention will be readily apparent to the skilled addressee from the following description of several embodiments, made by way of example only, with reference to the accompanying drawings, in which:

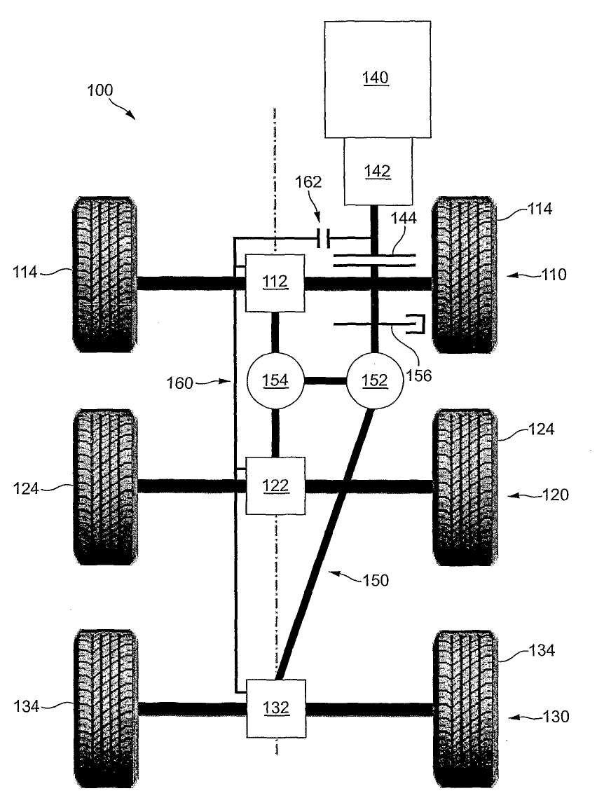

FIG. 1 is a schematic layout of a torque biasing driveline arrangement for a multi axle wheeled vehicle;

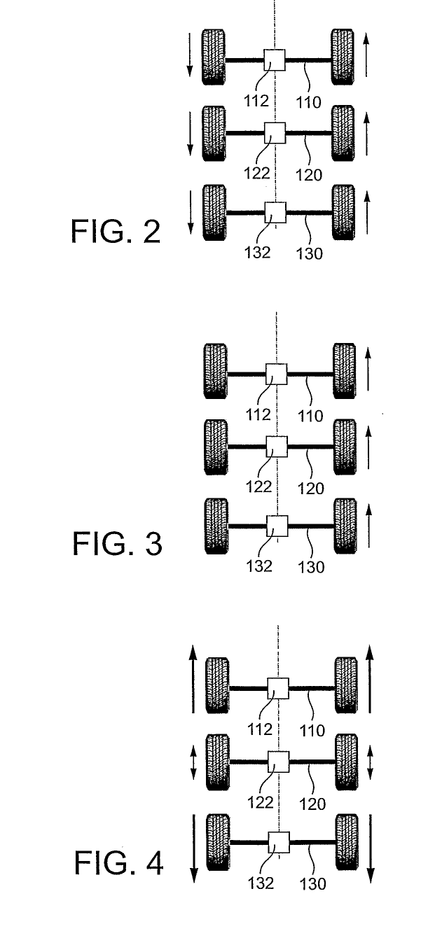

FIG. 2 is a schematic layout of a multi axle vehicle, wherein the wheels on one side of a vehicle have been caused to rotate in a first direction and the wheels on the other side of the have been caused to rotate in an opposite direction;

FIG. 3 is similar to FIG. 2, but wherein the wheels on one side of the vehicle are prevented from rotation, e.g. by braking;

FIG. 4 is similar to FIGS. 2 and 3, but wherein the axles at the extremity of the vehicle are caused to rotate at a much higher speed than the inner axle;

FIG. 5 is a schematic layout of a modified torque biasing differential incorporating an input from a second driveline;

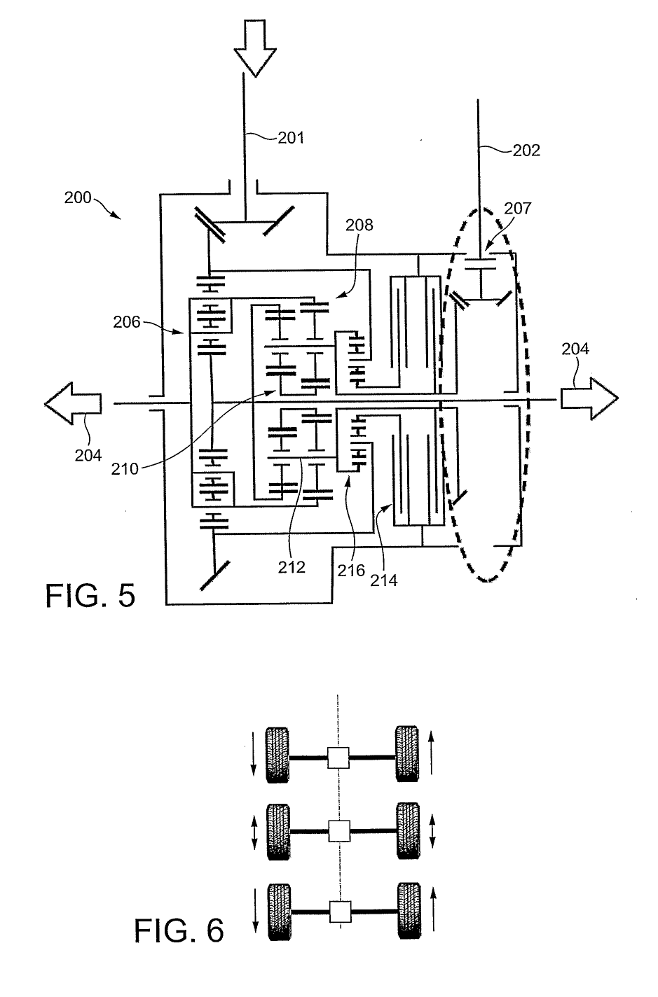

FIG. 6 is a view similar to FIGS. 2 to 4, wherein the axles at the extremity of the vehicle are caused to rotate at a higher speed than the inner axle, which is achieved using torque biasing modules which differ in configuration and/or input speed from the second drive path and/or clutch control within the second drive path from the torque biasing module at the inner axle;

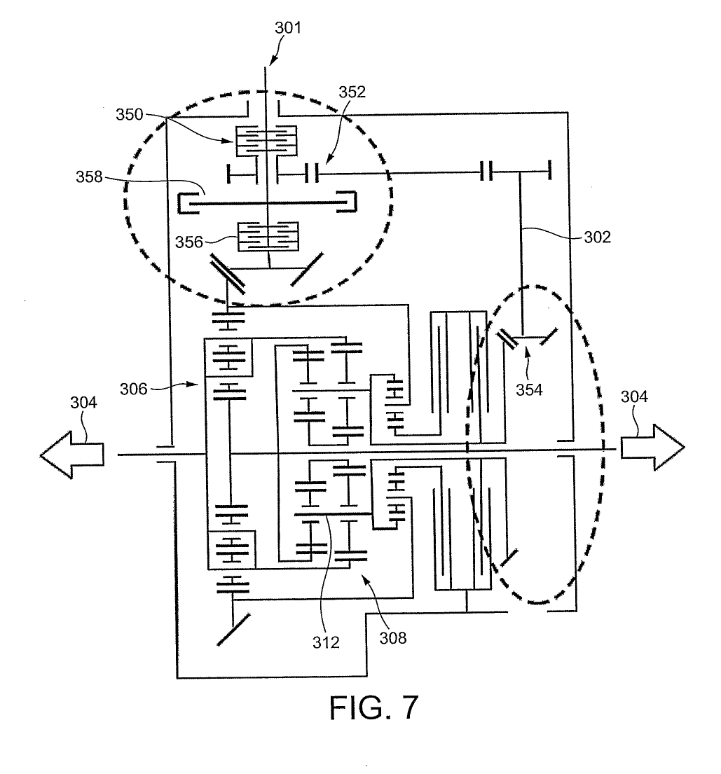

FIG. 7 is a schematic layout of a modified torque biasing differential incorporating a clutch for diverting drive from the main input to a second input for controlling the carrier of a torque biasing module within the differential;

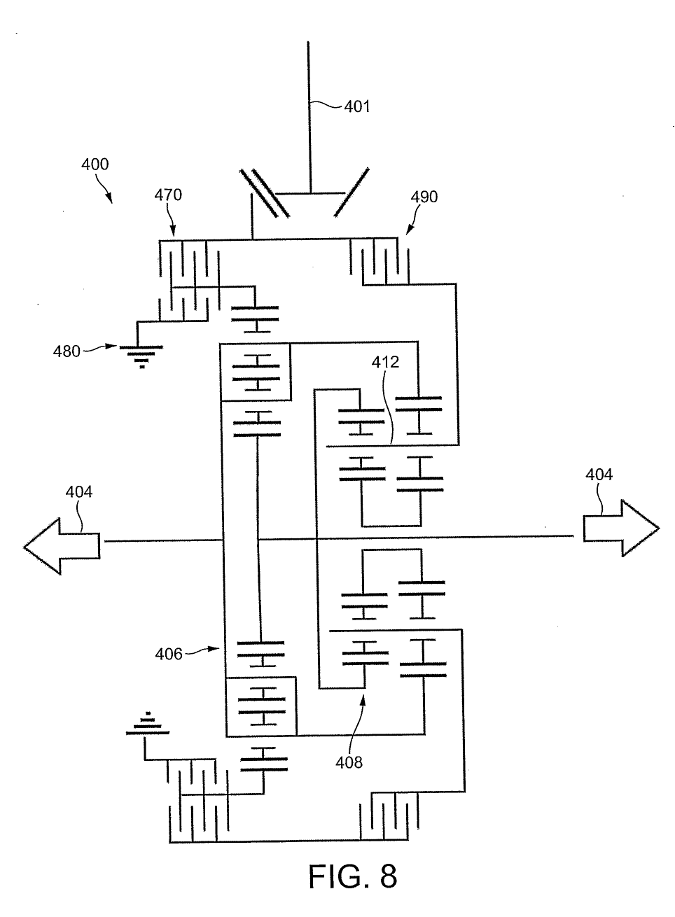

FIG. 8 is a schematic layout of a simplified torque biasing differential of the kind shown in FIG. 7.

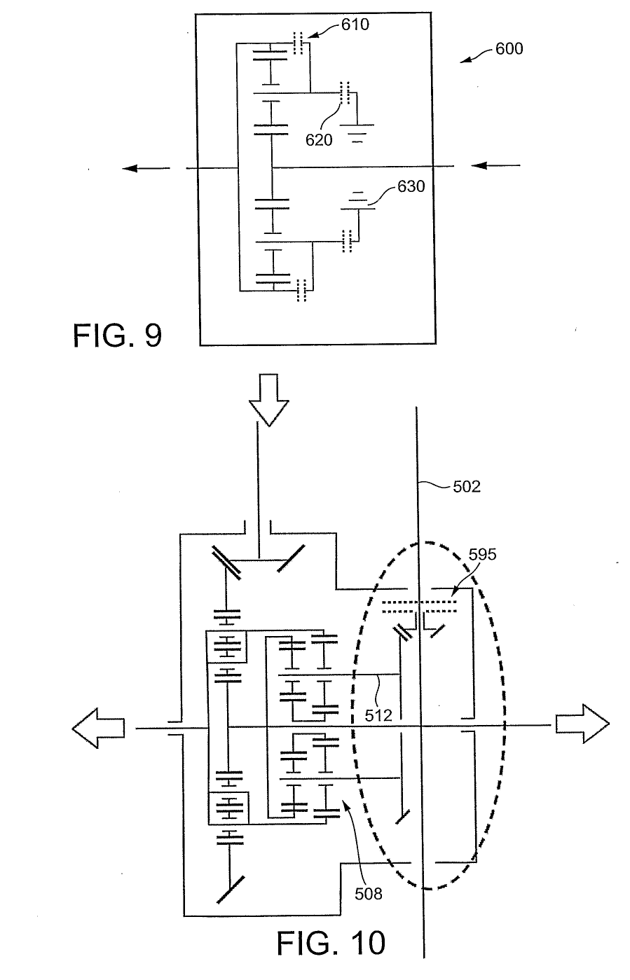

FIG. 9 is a schematic layout of an additional transmission device for use in reversing the rotational sense of the second driveline in the layout of FIG. 1;

FIG. 10 is a schematic layout of a simplified torque biasing differential of the kind shown in FIG. 5;

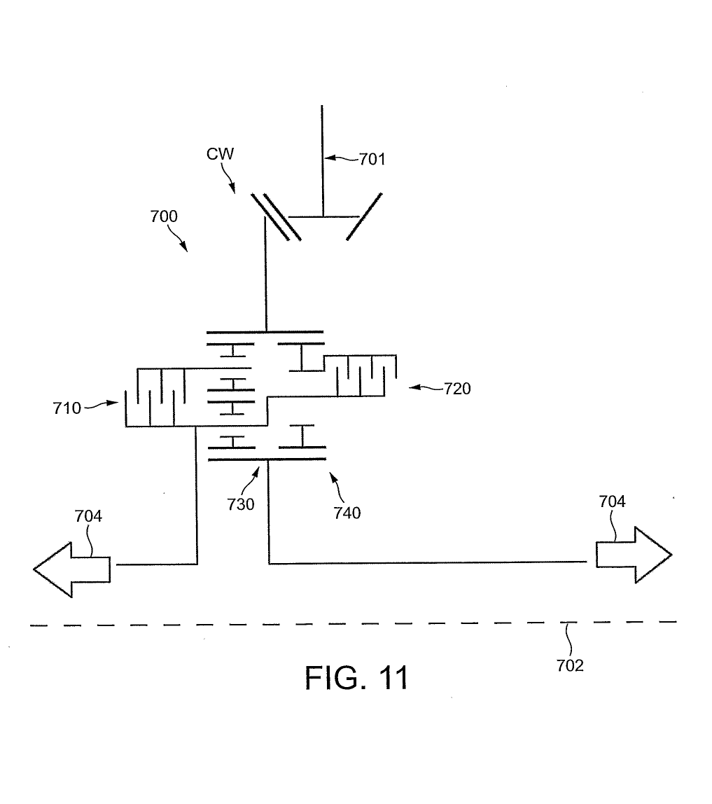

FIG. 11 a schematic layout of a pivot turn differential;

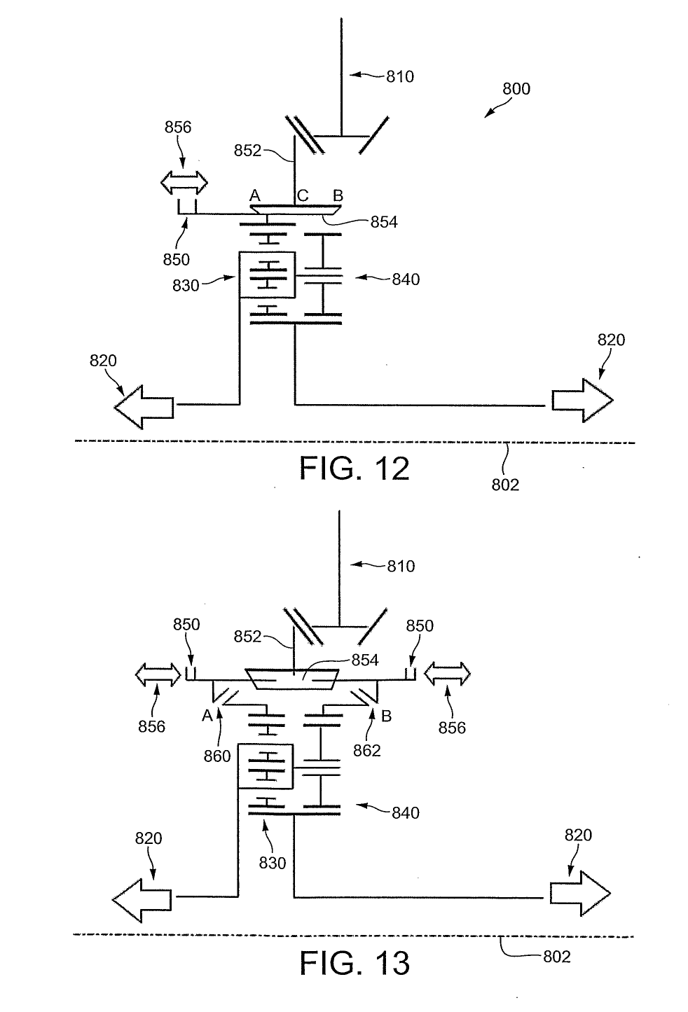

FIG. 12 is a schematic layout of a modified pivot turn differential incorporating an actuating sleeve;

FIG. 13 is a schematic layout of a bevel gear torque biasing axle differential; and

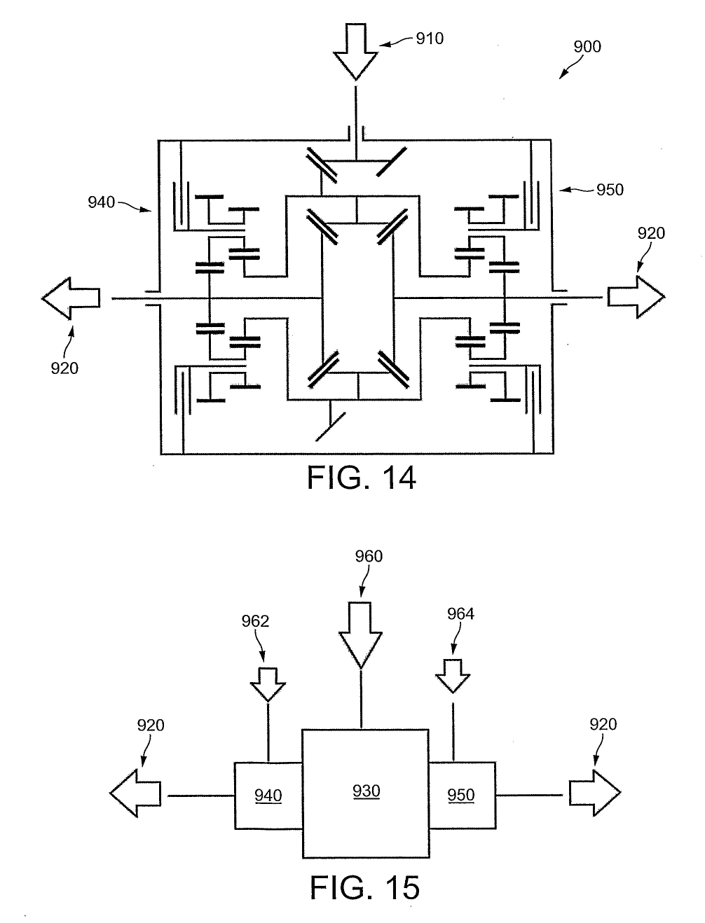

FIG. 14 is a schematic illustration of a multiple driveline arrangement for an axle differential of the kind shown in FIG. 14.

Referring firstly to FIG. 1, a driveline arrangement for a multi axle wheeled vehicle is indicated generally at 100. The vehicle includes three separate axles 110, 120, 130. Each axle incorporates an axle differential 112, 122, 132. Wheels 114, 124, 134 are provided on either side of the axles 110, 120, 130.

Each axle differential 112, 122, 132 includes two outputs, which comprise opposing drive shafts of the respective axle 110, 120, 130. The axle differentials 112, 122, 132 are in the form of torque biasing units, which are configured for varying the proportion of drive torque between their respective outputs. The torque biasing units are of generally known construction, for example of the kind shown in WO2006/010931.

Propulsive force is provided by an engine 140, via a transmission 142. However, in other embodiments the propulsive force may be derived from alternative sources, e.g. one or more motors.

The arrangement 100 includes a primary driveline indicated at 150, which is coupled to the transmission 142 by a clutch 144. In this embodiment, drive torque from the primary driveline 150 is split equally between the three axles 110, 120, 130 using a 67/33 split device at 152, a 50/50 split device at 154 and associated shafts of the primary driveline 150. Devices 152 and 154 may comprise conventional differential locks.

A brake device 156 is provided between the clutch 144 and the 67/33 split device 152 for selectively locking or retarding drive along the primary driveline 150. However, it may be preferred to operate devices 152 and 154 as differential locks, in which case the braking device may be located at another position, e.g. between 152 and 132, 112 and 154, 152 and 154, or 15.4 and 122 as viewed in FIG. 1.

The arrangement 100 further includes a second or auxiliary driveline indicated at 160, which is coupled to the output from the transmission 142 by, another clutch 162. The second driveline 160 is coupled to a control element within each axle differential 112, 122, 132, whereby drive can be provided to the axle differentials via said second driveline 160 independent from or in tandem with drive from said primary driveline 150.

Under normal operating conditions, clutch 144 is closed and brake 156 and clutch 162 are both open. Torque from the engine 140 is therefore split equally between the axles 110, 120, 130. The torque biasing differentials 112, 122, 132 are able to generate a yaw moment by biasing the torque output left and right of the respective axle (e.g. in a generally known manner using braking devices within the torque biasing module of the differential—see FIG. 5), thereby improving the overall stability of the vehicle when turning during forward and reverse movement.

Additional yaw moment can be imparted from the engine via the second driveline 160 by slipping the second clutch 162 (e.g. by partially closing the clutch 162).

If it is desired to cause the vehicle to pivot turn, i.e. to spin on the spot with the centroid of the vehicle acting as a nominally fixed pivot point, then the primary driveline 150 is decoupled from the engine by opening clutch 144, and drive from the engine 140 is transmitted to the second driveline 160 by closing clutch 162. Preferably, brake 156 is closed when clutch 144 is open, in order to prevent rotation of the primary driveline 150 (i.e. by grounding the conventional input to each axle differential 112, 122, 132).

With clutch 144 open and clutch 162 closed, torque from the engine 140 is transmitted to the second driveline 160 and in turn to the control element of each torque biasing unit 112, 122, 132. This causes the two outputs of each axle differential to rotate in opposite directions, e.g. as shown in FIG. 2. If first gear is selected, the vehicle will spin or pivot turn in a first direction, whereas engaging reverse gear will cause the vehicle to spin in the opposite direction. In both cases, the rate of spin is controlled by the engine speed (e.g. via the gas pedal).

A separate auxiliary control may be incorporated, e.g. wherein a controller can be used to decouple the primary driveline 150 and/or cause the vehicle to spin at one of a predetermined selection of rates if a ‘pivot turn’ mode is selected by the vehicle operator.

In other embodiments, the axle differential may be arranged in communication with a controller, e.g. the vehicle ECU, wherein the controller can be used to operate the axle differential, and to control the turning of the vehicle in response to one or more inputs, for example GPS data, data relating to stored geographical maps, proximity sensors, detectors for explosive devices such as land mines and other external ordinance detection systems. Such inputs can be used to prevent the vehicle colliding with objects during a turning operation. GPS inputs and the like can also be used to re-centre the vehicle in the event that the vehicle is caused to migrate from its nominal pivot point during a turning operation, e.g. if one or more wheels move over rough ground causing the vehicle to shift from its centre position. The controller can operate in tandem with other on board systems such as pressure systems for jacking or raising one or more axles and steering systems.

A switching device may be included in the second driveline 160 between the main transmission 142 and the first axle differential 112 (e.g. in place of clutch 162), to enable the arrangement to switch from forward gear causing clockwise rotation and reverse gear causing counter clockwise rotation to forward gear causing counter clockwise rotation and reverse gear causing clockwise rotation, and vice versa. The switching device may be of any suitable form. One example is shown at 600 in FIG. 9, wherein a clockwise clutch 610 and a counter clockwise brake 620 (both of which may be multi-plate arrangements) are used to change the output from clockwise to counter clockwise. The torque path can be grounded at 630, e.g. on the casing of the switching device 600.

The general concept described above is applicable to wheeled vehicles having two or more axles, wherein torque biasing axle differentials can be modified to cause the wheels on one side of the vehicle to rotate in a first direction and the wheels on the other side of the vehicle to rotate in an opposite direction (e.g. as shown in FIG. 2), to assist in turning of the vehicle, whether during forward or reverse movement or when the centroid of the vehicle is nominally stationary (during pivot turning). Other means may be used for controlling the rotation of each wheel to provide the scenario illustrated in FIG. 2, for example a selectively controllable motor for each wheel.

Provided that the wheels are rotating at generally the same speed, the kinetic energy at each wheel is generally the same, so that if one or more wheels encounters a high friction surface during movement of the vehicle, the vehicle is not caused to jolt from its notional centre of turning.

Of course, it may be preferred to lock the wheels on one side of the vehicle and to drive the wheels on the opposite side of the vehicle, as shown in FIG. 3.

In another method, the capability of a wheeled vehicle to spin on the spot is improved by increasing the speed of rotation of one or more of the extreme axles of the vehicle, e.g. front and rear axles 110, 130 in FIG. 1, relative to the speed of the inner axle(s). This reduces the lateral resistance of the tyre and hence the coefficient of friction between the vehicle and the ground surface, thereby reducing the torque required to induce a spin. An example is shown in FIG. 4, in which the drive to the front and rear axles 110, 130 is at high speed, preferably in opposing directions (indicated by the arrows in FIG. 4). A yaw movement can then be generated at the central axle 120, e.g. by rotating the wheels on either side of the axle in opposite directions (via a torque biasing axle differential or using independent electric motors), to control rotation of the vehicle in a desired direction.

An example of an axle differential for use in the embodiment of FIG. 1 is indicated generally at 200 in FIG. 5. The differential is in the form of a torque biasing unit of generally of known construction, e.g. as described in WO2006/010931, and so will not be discussed in significant detail.

For ease of reference, it is acknowledged that the unit 200 has a primary input 201, opposing outputs 204, a double planet epicyclic gear module 206 and a torque biasing module 208, and it will be understood that the unit 200 is capable of varying the proportion of drive torque between the two outputs in a generally known manner.

The torque biasing module 208 of the illustrated embodiment includes joined sun gears 210 and a control element in the form of a common planet carrier 212. Importantly, the unit 200 includes first and second drive paths for transmitting torque to the torque biasing module 208. The first drive path is generally conventional, in that torque is transmitted to the torque biasing module 208 from the primary input 201, via the epicyclic gear module 206. The second drive path, however, utilises an auxiliary or second input 202 which is arranged for transmitting torque to the torque biasing module 208 independently of the epicyclic gear module 206. In this embodiment, the second input 202 in the form of a pinion from the second driveline 160 in FIG. 1, and is coupled with the common planet carrier 212, for causing rotation thereof. Of course, it will be understood that the second input shaft 202 can be driven clockwise or counter clockwise, as desired.

A clutch 207 (e.g. a multi plate clutch) is provided for selectively decoupling the second input 202 from the second driveline 160, to enable independent control of the associated axle 110, 120, 130, as desired. The first and second drive paths of the unit 200 can be used in tandem or independently. Contra rotation of the axle outputs 204 is achieved if drive is transmitted via the second drive path when the input 201 from the primary drive line 150 is braked.

A modified axle differential is shown at 300 in FIG. 7 and similar reference numerals are used to denote similar components. In this embodiment, the need for the second driveline 160 of FIGS. 1 has been omitted. Rather, a second drive path is arranged for diverting torque from the primary input 301 (i.e. from the primary driveline of the vehicle, e.g. 150 in FIG. 1) to a second input 302 within the axle differential 300. More particularly, a clutch 350 is provided for selectively diverting torque from the primary input 301 to the planet carrier 312 of the torque biasing module 308, via a chain or gear arrangement 352, second input 302 and a bevel gear 354. An additional clutch 356 is provided for decoupling drive between the primary input 301 and the epicyclic input module 306 of the unit 300. In addition, a brake 358 is provided for grounding the annulus of the epicyclic input module 306. Contra rotation of the axle outputs 304 is achieved if drive is transmitted to the carrier 312 when clutch 356 is open and or if the brake 358 is applied. Of course, the first and second drive paths can be used independently or in tandem, as desired. Input 301 can be rotated clockwise or counter clockwise, as desired.

A simplified embodiment of a torque biasing unit for use in pivot turn applications is indicated at 400 in FIG. 8. Unlike the embodiments of FIGS. 5 and 7, it can be seen that this embodiment does not include brakes and associated gear devices in the torque biasing module 408.

An axle clutch 470 is provided for selectively coupling an input 401 to a double planet epicyclic input module 406. There is also provided an axle brake 480 for grounding annulus of the epicyclic input module 406. As with FIG. 7, the need for a second driveline 160 from the engine is obviated. In this embodiment, a carrier clutch 490 is included for selectively coupling drive from the input 401 to the planet carrier 412 of the torque biasing module 408 of the unit 400.

As will be understood from the description of FIGS. 1 and 5, by selecting first gear the vehicle can be caused to turn in a first rotational sense and by selecting reverse a turn of opposite rotational sense can be achieved, when drive to the epicyclic annulus is decoupled and directed to the carrier 412 via the clutch 490.

It may be preferred to incorporate a control unit, wherein if the vehicle operator selects ‘normal’ the axle clutch 470 is closed, the axle brake 480 is opened, and drive is transmitted in a conventional manner via the epicyclic input 406. However, if the operator selects a ‘pivot’ function, axle clutch 470 is opened, axle brake is closed 480, and pivoting movement is achieved by rotating the carrier 412 of the torque biasing module 408 so as to cause contra rotation of the outputs 404.

A simplified embodiment of the axle differential of FIG. 5 is shown at 500 in FIG. 10, wherein the brake and gears of the torque biasing module 508 are omitted. A clutch 595 (single or multi-plate) is provided for the second input shaft 502, which enables the carrier 512 the torque biasing module 508 to be independently controllable across each axle of the vehicle, as required. Also, the speed at which the carrier 512 rotates can be modulated by controlling slippage of the clutch 595 at each axle.

In a wheeled multi axle vehicle, each axle may include a torque biasing unit of the kinds described above. In one embodiment, the axles at the extremity of the vehicle can be arranged for rotation at a higher speed than the inner axle(s). This may be achieved using torque biasing modules within the axle differentials at the front and rear of the vehicle which differ in configuration, and/or input speed from along the second drive path, and/or clutch control within the second drive path, from the torque biasing module in the axle differential at the inner axle(s). The result is indicated in FIG. 6.

Although not illustrated in the drawings the epicyclic gear trains within the torque biasing modules described above may include double planet gears.

FIG. 11 shows a pivot turn differential 700 for a vehicle axle having a centre line 702. The differential 700 includes an input 701 and two outputs 704, with communication between the input 701 and outputs 704 via first and second drive paths. Each drive path includes and epicyclic gear train 730, 740 arranged in communication with a clutch or other form of coupling 710, 720, preferably of multi plate form. Epicyclic gear train 730 has an even number of planet gears and epicyclic gear train 740 has an odd number of planet gears 740. This arrangement of even and odd planetary gears means that if clutch 710 is closed and clutch 720 is open, the outputs 704 rotate in the same direction when receiving torque from the input 701. However, if clutch 720 is closed and clutch 710 is open, then the outputs 704 rotate in opposite directions. Simultaneous engagement (closing) of both clutches 710, 720 provides a diff-locked function, wherein the outputs 704 rotate as one.

FIG. 12 shows another pivot turn differential 800 having a centre line 802, an input in the form of a drive pinion 810, and two outputs 820. The differential 800 has a first drive path via a double planet gear train 830 and a second drive path via a single planet gear train 840. As described above, the double (even) planet gear train 830 enables rotation of the outputs 820 in the same direction, the single (odd) planet gear train 840 enables rotation of the outputs 820 in opposite directions, and the simultaneous use of the gear trains 830, 840 provides a diff lock function wherein the two outputs 820 rotate as one.

A sliding member is provided for the selective communication of drive between the input pinion 810 and the gear trains 830, 840. In this embodiment, the sliding member is in the form of a sleeve or ring gear 850 which slidably movable via a splined connection 854 with the differential crown wheel 852 (e.g. in the direction of arrows 856 in FIG. 12).

When the sleeve 850 is in position A, only the first drive path is engaged via the double planet gear train 830. When the sleeve 850 is in position B, only the second drive path is engaged via the single planet gear train 840. Clockwise or counter-clockwise yaw is achieved, dependent upon the direction of rotation of the input pinion 810.

If both gear trains 830, 840, e.g. when the sleeve 850 is in position C in FIG. 12, then the axle is diff locked.

In another embodiment, not illustrated, the sliding sleeve 850 is replaced by a sliding sun gear movable for selective engagement with a planet of one or both gear trains. 830, 840.

The sliding member 850 is suitable to engage or disengage from one or both of the gear trains 830, 840 when the vehicle is stationary.

A modified embodiment is shown in FIG. 13, having opposing sleeves 850 movable along the splined connection 854 for selective engagement with a respective gear train 830, 840 (although a single sleeve 850 may be preferred). A synchroniser 860, 862 is provided between the sliding member 850 and its associated gear train(s). The synchronisers 860,862 readily permit engagement/disengagement of the sliding member with the gear trains 830, 840 at speed.

Other devices may be provided for allowing engagement/disengagement of the gear trains under high prevailing torque, such as those described in WO2005/121586 (which is incorporated herein by reference).

FIG. 14 shows an alternative torque biasing differential 900, which includes an input in the form of a drive pinion 910 and two outputs 920. The differential 900 is distinct from the torque biasing differentials of FIGS. 5, 7, 8 and 10 in that it incorporates a bevel differential gear cluster 930 as opposed to an epicyclic differential par cluster. More particularly, the differential 900 includes first and second torque biasing gear clusters 940, 950, one on either side of the axle, for selectively controlling the torque at a respective output 920,

In this embodiment, each torque biasing cluster 940, 950 includes multiple epicyclic gear trains having a common planet carrier.

As indicated generally in FIG. 15, a first drive path 960 is arranged for providing torque to the differential cluster 930 and separate drive paths 962, 964 are arranged for providing torque to the torque biasing dusters 940, 950.

In this particular embodiment, drive path 962 is arranged to transmit drive to the common planet carrier of the torque biasing cluster 940 and drive path 964 is arranged to transmit drive to the common planet carrier of other torque biasing cluster 950. Torque may be diverted to the drive paths 962, 964 from the first drive path 960, or may be provided by independent of the first drive path 960, e.g. via separate drivelines and/or torque sources.

For a static pivot turn, it would be preferred to prevent rotation within the first drive path, e.g. using a brake or other locking device to ground the differential gear cluster 930.

It will be understood that the axle differentials and many of the concepts described herein are not only applicable to wheeled vehicles, but have application in marine craft, e,g. water craft having propeller or screw type devices (as opposed to wheels) arranged in communication with the outputs from the axle differential via one or more output shafts of the axle.

Any of the axle differentials or vehicles disclosed herein may be controlled via a controller of the kinds described above in relation to FIG. 1, including the pivot turn differentials of FIGS. 11 and 12.

1. An axle differential for a vehicle, the axle differential including two outputs and a mechanical arrangement configured for varying the proportion of drive torque between the two outputs, wherein the axle differential includes first and second input drive paths for transmitting torque to said mechanical arrangement.

2. An axle differential according to claim 1 in which the mechanical arrangement includes a differential gear cluster arranged in communication with a torque biasing gear cluster, wherein the torque biasing gear cluster is configured for varying the proportion of drive torque between the two outputs.

3. An axle differential according to claim 2 in which the first input drive path is configured for communication with said differential gear cluster and the second input drive path is configured for communication with said torque biasing gear cluster.

4. An axle differential according to claim 3 in which the torque biasing gear cluster includes a control element and the second input drive path is arranged for transmitting drive to said control element.

5. An axle differential according to claim 3 wherein the second drive path communicates with the torque biasing gear cluster independently of said first drive path.

6. An axle differential according to claim 3 wherein the second drive path is arranged for selectively diverting torque from said first drive path to said torque biasing gear cluster.

7. An axle differential according to claim 2 wherein the torque biasing gear cluster comprises one or more epicyclic gear trains arranged about one output of the axle differential.

8. An axle differential according to claim 7 wherein the epicyclic gear trains include a control element and the second drive path is arranged in communication with said control element independent of the differential gear cluster.

9. An axle differential according to claim 8 wherein the control element is in the form of a planet carrier common to at least two epicyclic gear trains.

10. An axle differential according to claim 2, comprising first and second torque biasing gear clusters, one for each output, and each having a plurality of epicyclic gear trains incorporating a planet carrier which is common to at least two epicyclic gear trains, wherein the second drive path of the axle differential is arranged for driving the common planet carrier of the first torque biasing gear cluster and an additional drive path is arranged for driving the common planet carrier of the second torque biasing gear cluster.

11. A vehicle having multiple axles wherein at least one axle incorporates an axle differential according to claim 1.

12. A vehicle according to claim 11 wherein the first drive path for said axle differential includes a drive shaft arranged for receiving input from the primary torque source of the vehicle.

13. A vehicle according to claim 12 wherein the second drive path is arranged for selective communication with the first drive path for diverting torque from the first drive path.

14. A vehicle according to claim 12 wherein the second drive path includes a drive shaft arranged for selective communication with the primary torque source of the vehicle.

15. A vehicle according to claim 12, wherein the second drive path includes a torque source separate from the primary torque source of the vehicle.

16-19. (canceled)

20. A method of controlling a torque biasing axle differential in a vehicle, the axle differential having a primary input for receiving torque from the engine of the vehicle, two outputs for driving wheels on either side of the vehicle, an epicyclic differential gear unit for receiving torque from said primary input, and a torque biasing unit for varying the torque between the outputs, the method including the steps of selectively applying torque to the torque biasing unit independently of the epicyclic differential gear unit via a second input.

21. A pivot turn differential for a vehicle axle, the differential including an input and two outputs, and two drive paths for communicating drive between the input and said outputs, each drive path having a selectively operable coupling arranged in communication with an epicyclic gear train, and wherein the epicyclic gear train for one of said drive paths has an even number of planet gears and the epicyclic gear train for the other of said drive paths has an odd number of planet gears.

22. A pivot turn differential according to claim 21 including a sliding member which is movable for selectively coupling drive between the input and said drive paths.

23. A pivot turn differential according to claim 22 wherein a separate sliding member is provided for coupling each drive path with the input.

24. A pivot turn differential according to claim 22 wherein each drive path includes a synchronizer for communication with the sliding member.
